(19) United States
(12) Patent Application Publication
(10) Pub. No.: US 2018/0279578 A1
(43) Pub. Date: Oct. 4, 2018

(54) PORTABLE PET BED AND METHOD OF USE

(71) Applicant: Anna Thomasson, Paradise Valley, AZ (US)

(72) Inventor: Anna Thomasson, Paradise Valley, AZ (US)

(21) Appl. No.: 15/938,004

(22) Filed: Mar. 28, 2018

Related U.S. Application Data
(60) Provisional application No. 62/477,798, filed on Mar. 28, 2017.

(51) Int. Cl. A01K 1/015

(52) U.S. Cl. CPC A01K 1/0157; A01K 1/06

(57) ABSTRACT

A device and method of use for a portable pet bed are described herein. The portable pet bed includes a decorative front/top panel and a backing back/bottom panel stitched together around the edges, creating a space for a fill, such as padded bedding or an absorbent pad. In some examples, the fill is removable through a slot in the second panel. Additionally, some examples of the pet bed include a tuck flap, therein the bed may be collapse and compressed for travel or storage by tightly rolling the bed and tucking it into a pouch formed by the tuck flap.

### CROSS REFERENCE TO RELATED APPLICATION

This application claims priority to U.S. Nonprovisional Patent Application to Anna Thomasson entitled “PORTABLE PET BED AND METHOD OF USE,” Ser. No. 62/477,798, filed Mar. 28, 2017, the disclosures of which are hereby incorporated entirely herein by reference.

### BACKGROUND OF THE INVENTION

### Technical Field

This invention relates to a pet bed. Specifically, the invention relates to a portable pet bed device and method of use for providing a collapsible, readily portable bed for a pet.

### State of the Art

Pets are ubiquitous throughout society. Pet owners may provide their animals with various accessories. In the case of dogs and cats, such accessories often include a padded bed. The pet bed is placed inside the home, and provides comfort and familiarity for the animal. Generally, a pet's bed remains in one place and is not moved around.

Because pets, such as dogs and cats, make such wonderful companions, they often travel with their owners. Travel is stressful for people and pets alike; therefore, it may be calming to the pet to have a familiar object, containing the pet's scent, such as its bed, present when travelling away from home. Pet beds, however, are bulky and awkward to carry, taking up much room in the trunk of an automobile, for example. Additionally, a pet may soil its bed, staining the cover and fouling padding of fill contained within. Cleaning a soiled pet bed is difficult because the bed is typically bulky and the padding/fill clumps up, does not dry properly, and can become lumpy or colonized with mildew from improper drying. These and other difficulties often lead an owner of a soiled pet bed to throw away the bed, either after laundering the bed ruins the fill, or even before any attempt at laundering or cleaning the soiled pet bed.

Accordingly, a better pet bed is needed which may be cleaned without ruining the fill and its padding characteristics, and also which may be easily collapsed and compressed to a convenient size and shape for travelling.

### SUMMARY OF EMBODIMENTS

The present invention discloses a device and method of use for a portable pet bed.

Disclosed is a portable pet bed comprising a first panel of stain-resistant fabric having a first predetermined length; and a first predetermined width; a second panel having a second predetermined length and a second predetermined width, said second length and width similar to the first length and width, coupled to the first panel at a seam, and comprising a slot in communication with the space, wherein the slot comprises the width; and divides the second panel into two second lengths; a tuck flap coupled to the first panel; a pouch bounded by the first panel and the tuck flap; and a space bounded by the first panel and the second panel, comprising a fill that may be inserted or removed through the slot.

In some embodiments, the pet bed further comprises a tuck flap coupled to the second panel; and a pouch bounded by the second panel and the tuck flap. In some embodiments, the two second lengths are equal. In some embodiments, one second length is four times greater than the other second length. In some embodiments, one second length is two times greater than the other second length. In some embodiments, the fill comprises a disposable absorbent body. In some embodiments, the fill comprises a washable absorbent body.

Disclosed is a method for collapsing a portable pet bed comprising steps rolling the pet bed to form a roll; and securing the roll by tucking the roll into a pouch coupled to the pet bed.

In some embodiments, the securing step comprises tying the roll with a tie. In some embodiments, the tie is coupled to the pet bed. In some embodiments, the method further comprises a step removing a fill from the pet bed.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a top perspective view of a portable pet bed according to an embodiment;

FIG. 2 is a bottom perspective view of a portable pet bed according to an embodiment;

FIG. 3 is a cross-sectional side view of a portable pet bed according to an embodiment;

FIG. 4 is a bottom perspective view of a portable pet bed with a slot according to an embodiment;

FIG. 5A is a top perspective view of a portable pet bed with a subdivided space according to an embodiment;

FIG. 5B is a cross-sectional side view of a portable pet bed with a subdivided space according to an embodiment;

FIG. 6A is a bottom perspective view of a portable pet bed with a tie according to an embodiment;

FIG. 6B is an additional bottom perspective view of a portable pet bed with a tie according to an embodiment;

FIG. 7 is a flowchart diagramming a method of use of a portable pet bed according to an embodiment;

FIG. 8A is a perspective view of a portable pet bed with a tuck pocket and a tie according to an embodiment;

FIG. 8B is a perspective view of a portable pet bed with a tuck pocket and a tie in a reversed condition according to an embodiment;

FIG. 9A is a perspective view of a portable pet bed in a partially rolled position according to an embodiment; and

FIG. 9B is a perspective view of a portable pet bed in a fully rolled and stored position according to an embodiment.

### DETAILED DESCRIPTION OF EMBODIMENTS OF THE INVENTION

Disclosed is a portable pet bed. The portable pet bed is readily collapsible and compactable for transport or storage. Additionally, some embodiments of the portable pet bed comprise a fill which may be easily and quickly removed from the portable pet bed for cleaning or replacement when soiled. Generally speaking, the portable pet bed is a rectangular-shaped mat for use by a dog or cat when sleeping or resting. The portable pet bed is formed in different dimensions and sizes suitable for a general size of the pet that will be using the portable pet bed. In some embodiments, these dimensions may be between about twenty (20) inches and about twenty-four (24) inches wide and between about thirty (30) and about forty (40) inches long, however these dimensions are offered as an example only and not meant to be limiting.

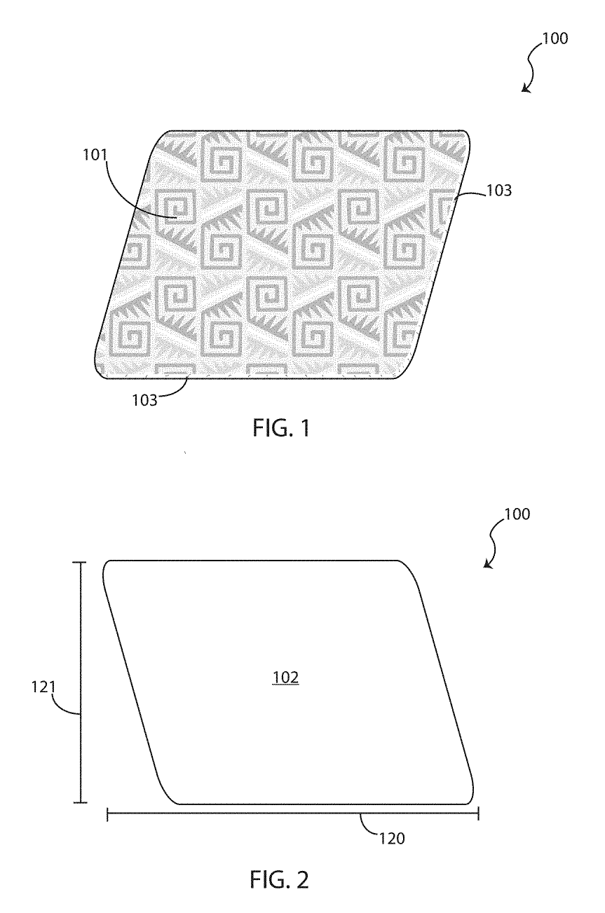

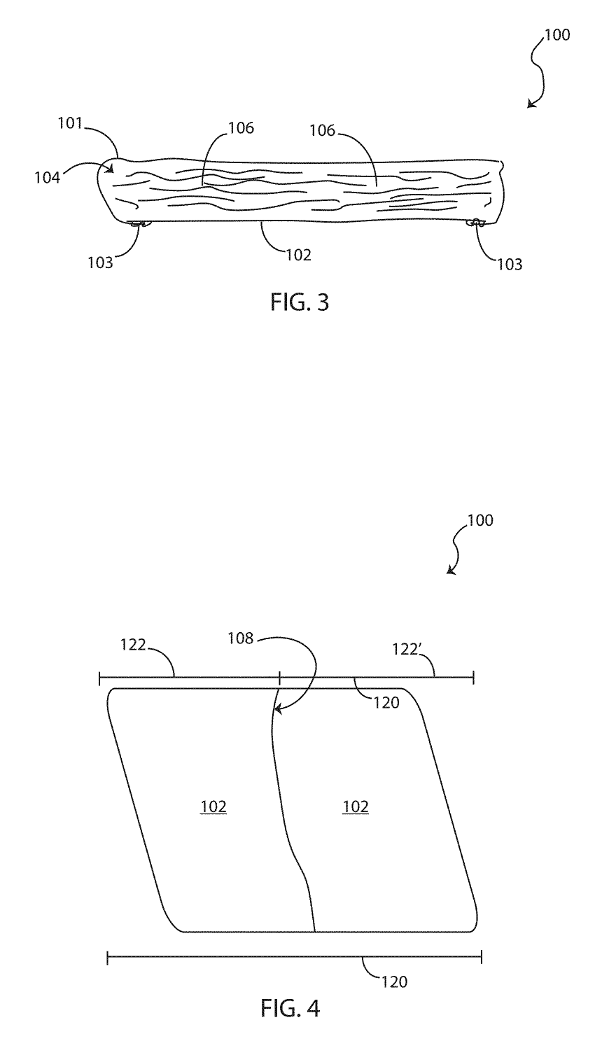

FIG. 1 is a top perspective view of a portable pet bed, FIG. 2 is a bottom perspective view of a portable pet bed, and FIG. 3 is a cross-sectional side view of a portable pet bed. As shown by FIG. 1, FIG. 2, and FIG. 3, a portable pet bed 100 comprises a (top) first panel 101 and a (bottom) second panel 102 coupled together along a seam 103. In the embodiment shown in FIGS. 1-3, seam 103 is located around the periphery of first panel 101 and second panel 102 such that first and second panels 101 and 102 are coupled only at the edges of each panel, creating a space 104 between first panel 101 and second panel 102. Space 104 is thus bounded by first panel 101 and second panel 102.

In the example embodiments shown in FIG. 2 the general dimensions of pet bed 100 has a length 120 and a width 121. The width of the bed is oriented perpendicular to bed length 120. In some embodiments, including the embodiment shown in FIG. 2, bed length 120 is greater than width 121, but this is not meant to be limiting. Bed length 120 and bed width 121 may be equal or about equal. Additionally, the general rectangular shape of portable pet bed 100 shown in the figures is not meant to be limiting. Portable pet bed 100 may be formed in the shape of a square, triangle, other polygon, circle, a complex shape comprising linear and curvilinear segments, and the like. In embodiments wherein portable pet bed 100 comprises a circular shape or a square shape, bed length 120 is equal or about equal to width 121.

Various considerations are to be noted in the choice of materials used in the manufacture of pet bed 100. For example, during deployment and use, pet bed 100 is positioned on a surface, such as the floor, with first panel 101 facing upwards and in view. Accordingly, first panel 101 may comprise a decorative pattern similar to the example shown in FIG. 1; artwork, quilting features, or the like. A pet, such as a dog or a cat, uses portable pet bed 100 for sleeping and resting, and soft textiles which are more comfortable for the resting pet may be used. Some pets, however, are inclined to scratch at bedding material. Also, a pet often harbors dirt or dust in its fur, and, with occasional exceptions, sheds its fur. A pet may soil its bed with emesis, urine, or other bodily secretions. Given the foregoing and other considerations, first panel 101 is manufactured from a durable, stain-resistant textile, comprising either natural or synthetic materials, or a blend of natural and synthetic materials, in some embodiments.

Second panel 102 rests on the floor or like surface while pet bed 100 is in use, and is typically neither visible nor contacted directly by the pet. Second panel 102, therefore, may be constructed from less soft, plain, yet reasonable durable material. In some embodiments, second panel 102 and first panel 101 are formed from the same material. In some embodiments, second panel 102 is formed from a different material than first panel 101. Acceptable materials for either first panel 101 or second panel 102 include, but are not limited to, washable polyester, cotton, and cotton/polyester blended fabrics.

Seam 103 is a boundary whereupon first panel 101 and second panel 102 are coupled together. In the particular embodiment shown in FIG. 1, seam 103 is visible from a perspective view. In this, and some other embodiments, edges of second panel 102 are manipulated to contact edges of first panel 101 and coupled to first panel 101. This is not meant to be limiting. In some embodiments, first panel 101 is folded downward to contact second panel 102, wherein seam 103 is visible from a bottom of pet bed 100, as shown in FIG. 3. FIG. 3 shows an embodiment of pet bed 100 wherein first panel 101 is rolled downward to contact and be coupled with second panel 102 at seam 103. FIG. 3 additionally shows space 104 located between first panel 101 and second panel 102. In some embodiments, space 104 comprises a fill 106. Fill 106 has one or any number of materials which create volume, are highly absorbable, or both create volume and are absorbable. In some other embodiments, first panel 101 and second panel 102 are equally opposed to meet one another along the sides of pet bed 100. Seam 103 comprises any number or combination of means for coupling fabric, whether natural or synthetic, such as stitching, gluing, annealing, and the like.

In some embodiments discussed herein below, fill 106 is removable from space 104. In some other embodiments, fill 106 is not readily removable from space 104. Fill 106 may comprise an absorbent pad, such as a disposable incontinence synthetic pad widely used in hospitals and nursing homes, in some embodiments. Alternatively, fill 106 may be formed from any number of natural or synthetic materials which provide cushioning and padding for a resting pet. Some non-limiting examples include polyester fibers, polyamide fibers, polypropylene fibers, conjugation of polyester, polyamide, and polypropylene fibers, other synthetic fibers, down, other feathers, wool, other natural fibers, or the like. In some embodiments, fill 106 measures about one (1) inch in thickness, but this thickness is offered by example only and not meant to be limiting. In some embodiments, fill 106 may be a unitary body formed generally in the shape and size of space 104. In some embodiments, fill 106 may be an amorphous material which is evenly distributed throughout space 104. Fill 106 may be washable, depending upon whether the composition of fill 106 is a material which may be laundered.

FIG. 4 is a bottom perspective view of a portable pet bed with a slot 108. In addition to the elements described herein above, in the embodiment of pet bed 100 shown in FIG. 4, second panel 102 comprises slot 108 in communication with space 104. Slot 108 provides ready access to space 104 for removal of fill 106, such as to launder or replace fill 106. For example, wherein pet bed 100 becomes soiled, fill 106 comprising an absorbent pad may be removed and thrown away, and the remainder of pet bed 100 may be laundered. A fresh, clean replacement absorbent pad/fill 106 may then be positioned in space 104 through slot 108. Fill can be removed through slot 108 and the bed can be turned inside out and provide a reversible feature with a different design. The fill or pad can be reinserted through slot 108. Slot 108 can be closed by means of hook-and-loop closure (Velcro®), a reversible zipper, buttons or similar method. Because pet bed 100 is reversible, in some embodiments, it is advantageous for slot 108 lacking an attached closure mechanism, lacking a zipper, or to utilize a Velcro® closure.

FIG. 4 additionally shows bed length 120 subdivided into a second length 122 and a second bed length 122′. Second bed length 122 is a distance from width 121 at a side of pet bed 100 to slot 108, wherein the relative position of slot 108 along length 120 is described. In embodiments of pet bed 100 not comprising slot 108, such as the embodiment shown in FIG. 2, second bed length 122 and second bed length 122′ are absent. In some embodiments, including the embodiment shown in FIG. 4, second bed 122 and second bed length 122′ are equal or about equal. This is not, however, meant to be limiting. In some embodiments (not shown in the drawing figures), second bed length 122 is about four times greater than second bed length 122′. In some embodiments, second bed length 122 is about two times greater than second bed length 122′. In some embodiments, one second bed length 122 is some other multiple of length greater than second bed length 122′.

Not all embodiments of pet bed 100 comprise slot 108. In some embodiments, such as the embodiment shown in FIG. 2, wherein slot 108 is absent, there is no readily available access to space 104. In this and similar embodiments, fill 106 is permanently positioned and cannot be removed from space 104 for cleaning or replacement.

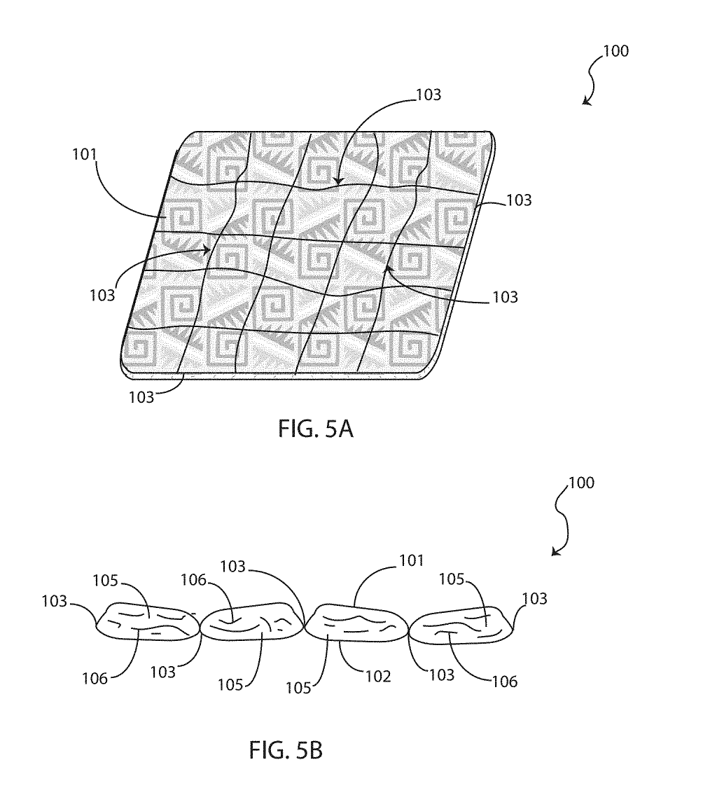

FIG. 5A is a top perspective view of a portable pet bed wherein space 106 is subdivided. In some embodiments of portable pet bed 100 lacking slot 108, wherein fill 106 is permanently positioned in space 104, first panel 101 may be stitched or otherwise coupled to second panel 102 in locations other than the periphery of first panel 101 and second panel 102. Such coupling may comprise a quilting stich, for example, wherein space 104 is subdivided into a plurality of subdivided spaces 105, and a portion of fill 106 is thus confined in each of the plurality of subdivided spaces 105. Wherein a quilting or similar decorative stich is used, subdivided spaces 105 may add to the decorative appearance of portable pet bed 100. Additionally, subdivided spaces 105 fix portions of fill 106 in position, resisting displacement of fill from a large area of space 104 and maintaining a more equal distribution of fill 106 within space 106, keeping fill 106 from moving/shifting when in use, for increased pet comfort.

FIG. 5B is a cross-sectional side view of a portable pet bed with a subdivided space. The plurality of subdivided spaces 105 comprising fill 106 are shown. Additionally, a plurality of seams 103 coupling first panel 101 to second panel 102 at multiple locations across panel 101 and panel 102 are illustrated by FIG. 5B and FIG. 5A.

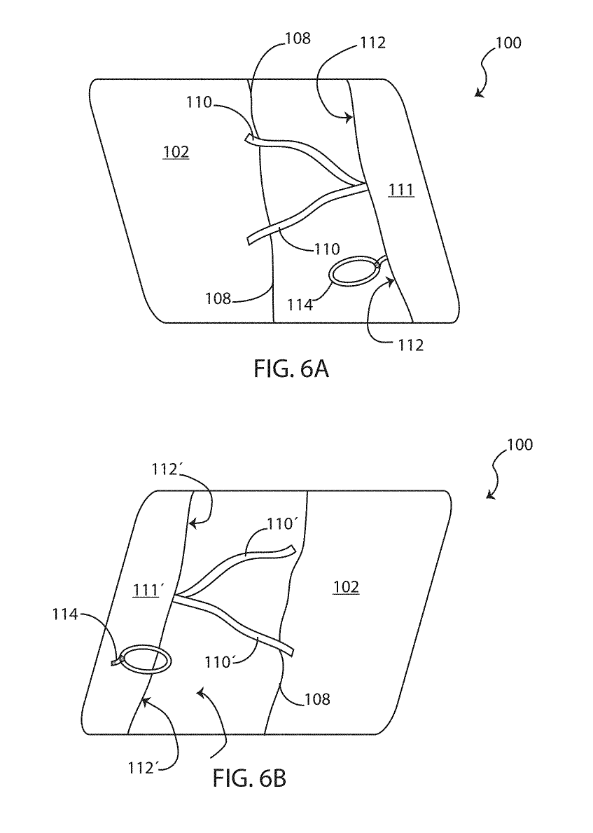

FIG. 6A is a bottom perspective view of a portable pet bed with a tie. FIG. 6B is an additional bottom perspective view of a portable pet bed with a tie. FIGS. 6A shows a tuck flap 111 coupled to a panel of the portable pet bed 100. Tuck flap 111 provides a means wherein portable pet bed 100 may be rapidly collapsed, compressed, and secured for travel or storage, as described herein below. In the embodiments shown in FIG. 6A-B, tuck flap 111 is coupled along three sides, leaving a fourth free-side to form an opening into a pouch 112. In some embodiments, bed 100 additionally comprises a tie 110 coupled to tuck flap 111. Pouch 112 is a space defined by first panel 101 or second panel 102. In some embodiments, pouch 112 is between about six (6) and about eight (8) inches deep, however this is offered by example and not meant to be limiting.

In some embodiments, including the embodiment shown in FIG. 6B, a tuck flap 111′ is coupled to the inside of coupled to a panel of bed 100, and a tie 110′ coupled to tuck flap 111′. In some embodiments, including the embodiment shown in FIG. 6A, the panel coupled to tuck flap 111 is second panel 102; in some embodiments, the panel coupled to tuck flap 111 is first panel 101. In some embodiments, portable pet bed 100 comprises a tuck flap 111′ coupled to the inside of a panel of bed 100, either first panel 101 of second panel 102, forming a pouch 112′. Under a condition wherein tuck flap 111 and tie 110 are externally visible over second panel 102, tuck flap 111′ and tie 110′ occupy space 104 and are not externally visible. In these and related embodiments, portable pet bed 100 is reversible, meaning bed 100 may be turned inside-out through slot 108. Thus, regardless of which side of decorative cover 101 is displayed, either tuck flap 111 and tie 110 or tuck flap 111′ and tie 110′ are present on the outside of bed 100, wherein a user may roll bed 100, pass the roll under either tuck flap 111 or tuck flap 111′ into either pouch 112 or pouch 112′, securing the rolled bed 100 with either tie 110 or tie 110′.

In some embodiments, portable pet bed may be rolled up along width 121 and the rolled bed inserted beneath tuck flap 111 into pouch 112. In embodiments comprising tie 110, rolled pet bed 100 may be secured in within pouch 112 by tying tie 110 encircled around the rolled bed 100. Tie 110 may comprise a cord, a ribbon or similar cloth segment, or the like. In some embodiments, tie 110 is not coupled to the pet bed; rather, tie 110 is a separate article which is used to tie the rolled portable pet bed 100. In some embodiments (not shown in the Figures), tie 110 is coupled to first panel 101 or second panel 102. In some embodiments (not shown in the Figures), tie 110 is coupled to length 120 along seam 103.

FIGS. 6A-B additionally show an optional leash loop 114. In some embodiments of pet bet 100, leash loop 114 is coupled to tuck flap 111 at an inner surface of tuck flap 111. In some embodiments, leash loop 114 is coupled about two (2) inches inside a free edge of tuck flap 111, although this is not meant to be limiting. In some embodiments, leash loop 114 is about one (1) inch in length; again, this measurement is not meant to be limiting. In some embodiments, leash loop 114 is coupled to an outer surface of tuck flap 111, as shown by FIG. 6B, for use under a condition wherein pet bed 100 is reversed (turned inside-out through slot 108). Leash loop 114 provides a means wherein a pet's leash may be folded repeatedly on itself to decrease its size, and then passed through leash loop 114, wherein leash loop 114 retains the folded configuration of the leash, for storage and transport with pet bed 100. Alternatively, the leash may be clipped to leash loop 114 and tucked into tuck flap 111, providing a secure storage for the leash when pet bed 100 in in use.

In some embodiments, a treat pouch (not shown) is coupled to the inside surface of tuck flap 111. The treat pouch may be a square-shaped pocket, such as an about three (3) inch by about three (3) inch pocket, for example, to store pet treats or similar small pet-related items. In some embodiments, the treat pouch measures about two (2) inches by about two (2) inches, however this is not meant to be limiting. In some embodiments, the treat pouch is coupled to the outer surface of tuck flap 11, for use under a condition wherein pet bed 100 is reversed.

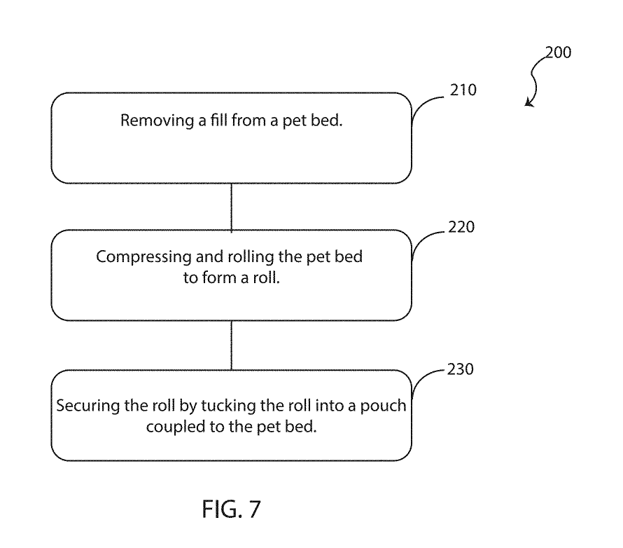

FIG. 7 is a flowchart diagramming a method of use of a portable pet bed. FIG. 7 shows a method 200 comprising a removing step 210, a compressing and rolling step 220 and a securing step 230.

Removing step 210 comprises removing a fill from a pet bed, wherein the pet bed comprises a slot for access to a space comprising the fill. This enables a user of the pet bed to easily remove fill which may have become wet or soiled. In some embodiments, the fill is disposable and may be responsibly discarded. The remainder of the pet bed may then be laundered or cleaned, and the soiled fill replaced by inserting fresh, clean fill through the slot and into the space. One non-limiting example of a disposable fill is a pre-fabricated absorbent pad, such as a urinary incontinence pad widely used in veterinary offices, hospitals, nursing homes, and other settings. In some alternative embodiments, the fill may be laundered or cleaned for eventual replacement into the space of the pet bed. A non-limiting example of a washable fill is a mat of polyester fibers, such Holofill™, or the like.

Compressing and rolling step 220 comprising rolling the portable pet bed to form a roll. A user may roll the pet bed along a width (or a length) of the pet bed, manually compressing the pet bed as it is rolled into a compact roll, wherein the pet bed is collapsed and compressed into a reduced volume with a smaller “footprint” which takes up substantially less space, wherein transport of storage of the pet bed is facilitated.

Securing step 230 comprises securing the roll. In some embodiments, securing the roll also comprises tucking the rolled pet bed into a pouch created between a tuck flap and a panel of the pet bed, wherein the rolled-up pet bed is constrained in the pouch between the tuck flap and the panel, such as a first panel or a second panel, and is not free to unroll. In some embodiments, securing the pet bed includes tying a tie, such as a ribbon, a cord, an elastomeric member, or the like, around the rolled pet bed. In some embodiments, securing step 230 comprises both tucking the rolled pet bed into the pouch and tying the rolled-pouched pet bed with the tie.

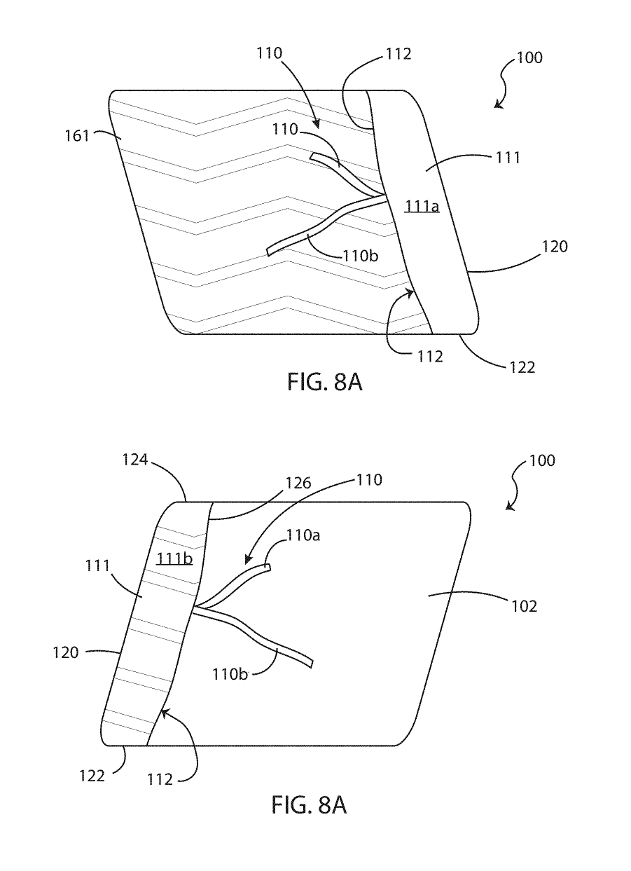

Referring further to the drawings, FIGS. 8A and 8B depict and embodiment of a pet bed 100 having a first panel 101 and a second panel 102 coupled together on edges by a seam and filled with fill material 106. First and second panels 101 and 102 may be extended and folded over to form a tuck flap 111 and coupled to the first and second panel 101 and 102 with seams 122 and 124 formed on opposing sides of the bed 100 to form a folded edge 120, which may also be a seam 120. The fill material 106 is located within the space between the first and second panel 101 and 102 and does not extend into the tuck flap 111. This creates an opening 112 and storage space to allow the remaining portion of the pet bed 100 to be folded or rolled up and inserted or tucked within the storage space through opening 112. The bed 100 may include a tie 110 coupled to an edge 126 of the tuck flap 111, the tie 110 having a first portion 110 a and a second portion 110b, wherein first portion 110a is shorter in length than second portion 110b.

The pet bed 100 is reversible. For example, and without limitation, referring to FIG. 8A, tuck flap 111 is folded over first panel 101 to expose tuck flap material 111a, which is the material of second panel 102. The tuck panel 111 may be folded over, as shown in FIG. 8B wherein the tuck flap 111 is folded over second panel 102 to expose tuck flap material 111b, which is the material of first panel 101. In at least this way, the pet bed 100 is reversible.

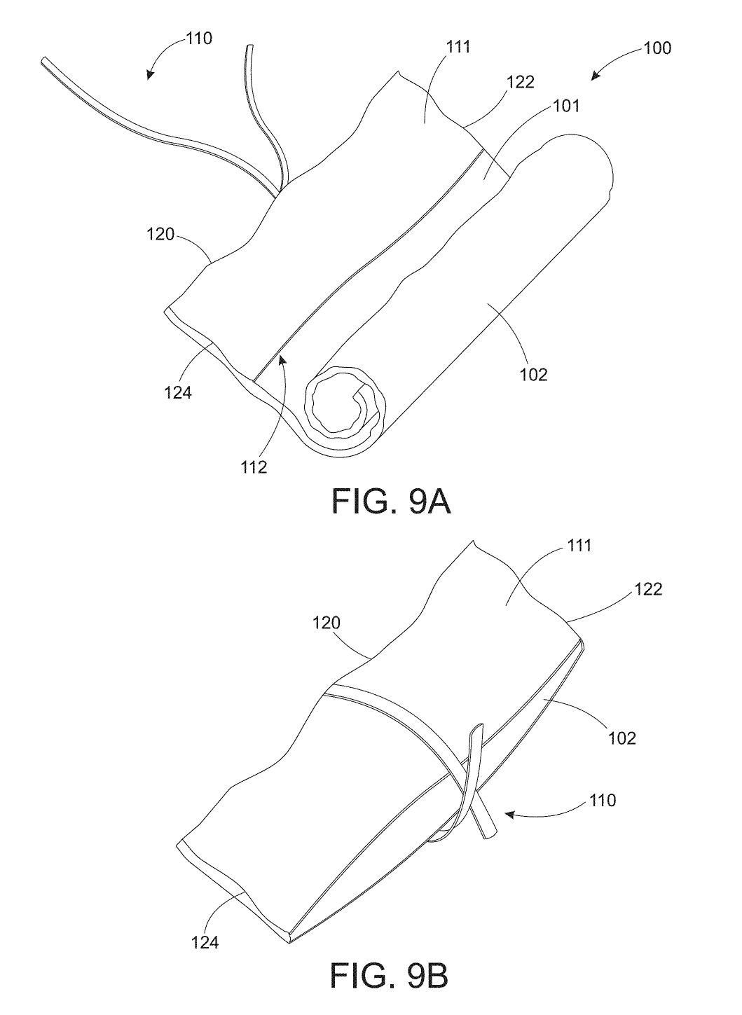

In operation and with reference to pet bed 100, first panel 101 and second panel 102 may be rolled or folded over itself from an end opposite the tuck flap 111 as shown in FIG. 9A. The folded or rolled first and second panel 101 and 102 may then be inserted through opening 112 and into a storage space formed between tuck flap 111 and first panel 101 and bound on sides 122 and 124 with seams and a folded or seamed edge 120. The tie 110 may then be wrapped around and tied to secure the inserted portion of the folded or rolled first and second panels 101 and 102 within the storage space to maintain the pet bed 100 in a storage position.

This invention overcomes the aforementioned and other difficulties encountered with using prior art, such as exchanging soiled fill, maintain a clean and attractive appearance, and the inability to easily collapse and compress a pet bed into a non-bulky article for ease of transport or storage.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above and the forth coming claims.

What is claimed is:

1. A portable pet bed comprising:
a first panel of stain-resistant fabric;
a second panel coupled to the first panel along a seam extending around a perimeter edge of the first panel and the second panel;
a space bounded by the first panel coupled to the second panel;
a tuck flap formed of an extended portion of the first and second panels coupled together, wherein the tuck flap is folded over the first panel and coupled to the first and second panels with tuck seams formed on opposing sides of the portable pet bed to form a folded edge extending between the tuck seams; and
a fill occupying the space without extending into the tuck flap.

2. The pet bed of claim 1, wherein the pet bed is reversible.

3. The pet bed of claim 2, wherein the pet bed is reversible in response to folding the tuck flap over the second panel.

4. The pet bed of claim 1, wherein the tuck flap folded over the first panel forms a storage space between the tuck flap and the first panel.

5. The pet bed of claim 4, wherein the remaining portion of the first panel coupled to the second panel is rolled or folded over itself and inserted within the storage space to place the pet bed in a storage position.

6. The pet bed of claim 1, further comprising a leash loop coupled to the pet bed.

7. The pet bed of claim 1, wherein the two second lengths are about equal.

8. The pet bed of claim 1, wherein one second length is about two times greater than the other second length.

9. The pet bed of claim 1, wherein the space is subdivided.

10. The pet bed of claim 1, wherein the fill comprises a disposable absorbent body.

11. The pet bed of claim 1, wherein the fill comprises a washable absorbent body.

12. The pet bed of claim 1, further comprising a leash loop coupled to the tuck flap.

13. A portable pet bed comprising:
a first panel;
a second panel coupled to the first panel along a seam extending around a perimeter edge of the first panel and the second panel;
a space bounded by the first panel, the second panel;
a tuck flap formed of an extended portion of the first and second panels coupled together, wherein the tuck flap is folded over the first panel and coupled to the first and second panels with tuck seams formed on opposing sides of the portable pet bed to form a folded edge extending between the tuck seams;
a fill occupying the space without extending into the tuck flap; and
a tie coupled to an edge of the tuck flap for securing the pet bed in a storage position.

14. The pet bed of claim 13, wherein the tuck flap and the tie operate for collapsing, compressing, and retaining the pet bed in the storage position.

15. The pet bed of claim 13, wherein the tie is an elastomeric member.

16. The pet bed of claim 13, wherein the tie is formed of a first portion and a second portion, wherein the first portion is shorter in length that the second portion.

17. The pet bed of claim 16, wherein the tuck flap folded over the first panel forms a storage space between the tuck flap and the first panel.

18. The pet bed of claim 17, wherein the remaining portion of the first panel coupled to the second panel is rolled or folded over itself and inserted within the storage space to place the pet bed in a storage position.

19. The pet bed of claim 18, wherein the second portion of the tie is wrapped around the pet bed in the storage position and tied to the second portion of the tie.

20. The pet bed of claim 13, wherein the pet bed is reversible in response to folding the tuck flap over the second panel.
